(19) United States
(12) Patent Application Publication
(10) Pub. No.: US 2009/0294247 A1
(43) Pub. Date: Dec. 3, 2009

(54) OVERSPEED PROTECTION DEVICE FOR ESCALATOR OR MOVING WALKWAY

(76) Inventors: Feng Xu, Zhejiang Province (CN); Jie Hu, Zhejiang Province (CN); Mingping Jiang, Zhejiang Province (CN)

Correspondence Address: CARLSON GASKEY & OLDS, 400 W MAPLE STE 350, BIRMINGHAM, MI, 48009, US

(21) Appl. No.: 12/299,188

(22) PCT Filed: May 8, 2007
(86) PCT No.: PCT/CN07/01496

§ 371 Date: May 12, 2009

(30) Foreign Application Priority Data
May 4, 2006 (CN) 200610079575.2
May 4, 2006 (CN) 200620019741.5

(51) Int. Cl. B66B 29/00; F16D 59/00

(52) U.S. Cl. 198/323; 188/185

(57) ABSTRACT

An overspeed protective device connected to the rotary shaft (3) of a drive machine in an escalator or a moving walkway is disclosed. The escalator or moving walkway includes a safety switch (9) for controlling electric current to be fed to the machine. The overspeed protective device comprises a rotation unit connected to the rotary shaft (3) so that it rotates with the rotary shaft, said rotation unit including a rotating bottom plate (2), at least one centrifugal weight (14), one end of which is pivotally connected to the rotating bottom plate (2); spring (11), one end of which is connected to the weight (14); and limiting screws (13) provided on each of the two sides of the weight. The overspeed protective device also comprises a control arm unit consisting of a drive rod (16), a slide rod (17) and a bent rod (7), the bent rod (7) comprising a first surface (7-1), a second surface (7-2) and a third surface (7-3), wherein the first surface allows power to be fed to the drive machine when it engages with the safety switch, the second surface prevents power from being fed to the drive machine when it engages with the safety switch, and the third surface is used to prevent the automatic resetting of the safety switch (9).

### FIELD OF THE INVENTION

The present invention relates to an overspeed protective device, and particularly to an overspeed protective device for an escalator and moving walkway.

### DESCRIPTIONS OF THE RELATED ART

Escalators and moving walkways which can efficiently transport a throng of people are widely used in many large public places such as commercial centers, subways and airports. Hence, the safety of these escalators and moving walkways are particularly important. According to relevant industrial standards, an escalator and moving walkway shall be equipped with a speed-limiting device so that when it operates at a speed above 120% of the rated speed, the escalator or moving walkway can be shut down automatically; moreover, when the operating speed exceeds 120% of the rated speed, the speed-limiting device shall be able to switch off the power supply of the escalator and moving walkway.

Currently, overspeed protective devices of the inductive pulse counter type are commonly used. Although such devices are easy to mount and use, unfortunately, they are known to be not very reliable and the induction circuits used are susceptible to interference and consequent failure. Further, in combination with the overspeed protective device of the inductive pulse counter type, a speed measuring block, which contains lead (Pb), is provided in the drive machine of such devices, which is harmful to the human body. In view of this, an overspeed protective device that uses a permanent magnet synchronous motor to drive an escalator and moving walkway is disclosed in Chinese Patent Application No. 03114907.3, which is characterized in that the overspeed protective device consists of a centrifugal weight, a switch, an acceleration transmission pair and an acceleration disk. However, this type of mechanical overspeed protective device has a complex structure, a large volume and high cost.

### SUMMARY OF THE INVENTION

The object of the present invention is to overcome at least one of the problems and shortcomings of overspeed protective devices of the prior art.

According to an embodiment of the present invention, an overspeed protective device connected to a rotary shaft of a drive machine in an escalator or walkway is provided. The escalator or moving walkway includes a safety switch for controlling electric current to be fed to the drive machine. The overspeed protective device comprises a rotation unit, which is connected to the rotary shaft so that they rotate together; a first centrifugal component mounted on the rotation unit, comprising a first weight, one end of which is pivotally connected to the rotation unit; and a control arm unit, comprising a first end adapted to engage with the weight and a bent rod, wherein the bent rod comprises a first surface, which allows power to be supplied to the drive machine when said surface engages with the safety switch; a second surface, which prevents power from being supplied to the drive machine when said surface engages with the safety switch; and a third surface, which is used to prevent movement between the first surface and the second surface.

According to another embodiment of the present invention, a mechanical overspeed protective device connected to a rotary shaft of a machine is provided, comprising:

a rotation unit comprising a rotating bottom plate inserted over the rotary shaft; at least one centrifugal component mounted on the rotating bottom plate and comprising a spring, a weight and limiting screws, wherein one end of the weight is pivotally connected to the rotating bottom plate, one end of the spring is connected to the weight and the other end fixed to the rotating bottom plate, and the limiting screws are disposed on at least one side of the weight; and

a control arm unit, comprising a drive rod, a slide rod and a bent rod, wherein the drive rod and the bent rod are located at two sides of the slide rod respectively, and the drive rod can engage with the weight of the rotation unit.

As compared with the prior art, the present invention provides the following benefits:

1. a plurality of apertures are opened in an area where the weight is connected to the spring, and the spring is hooked into one of the apertures. This allows an operator to adjust the tension of different springs by adjusting the clearance between the control arm unit and the weight freely, thereby to compensate for manufacturing tolerances in the stiffness of the springs, reduce the influence imposed by differences between individual springs, and make the entire device more reliable.

2. Two sets of springs, weights and limiting screws are mounted on the rotating bottom plate symmetrically to facilitate balancing. As the components are mounted after being well balanced, the overall device may run smoothly without any excitation due to shocks.

3. The entire device is of a modular design in which the rotation unit and the control arm unit are designed separately, are easy to mount and are interchangeable, so that only slight or even no modifications need be made when the device is mounted on drive machines with different rotational speeds and different rotary shafts.

4. The bent rod in the control arm unit is formed with bent surfaces, in order to ensure that the safety switch does not reset automatically after being depressed.

5. Most parts of the device are connected by means of standard parts, so that they are simple to manufacture, simple to replace on site, inexpensive and conveniently maintained.

6. It is convenient to test the device on site in the following manner: by fixing a mass block to the weight using a socket head screw M4*8, an overspeed test can be performed without the use of a frequency converter; and since the mass of the mass block is easy to control, the device can operate correctly in response to an overspeed state when the mass block is removed.

### BRIEF DESCRIPTION OF THE FIGURES

FIG. 1 is a schematic view illustrating a structure of a mechanical overspeed protective device according to an embodiment of the present invention;

FIG. 2 is a top view of FIG. 1 with the fan and fan cover removed;

FIG. 3 is a view along direction A in FIG. 2; and

FIG. 4 is an enlarged view of portion B in FIG. 3.

### DESCRIPTION OF THE PREFERRED EMBODIMENT

Hereinafter, the present invention and embodiments thereof will be further explained in detail with reference to the attached drawings. However, the following description of the present invention with reference to the attached drawings is only provided to explain inventive concepts of the present invention, and shall not be construed as limiting the scope of the present invention.

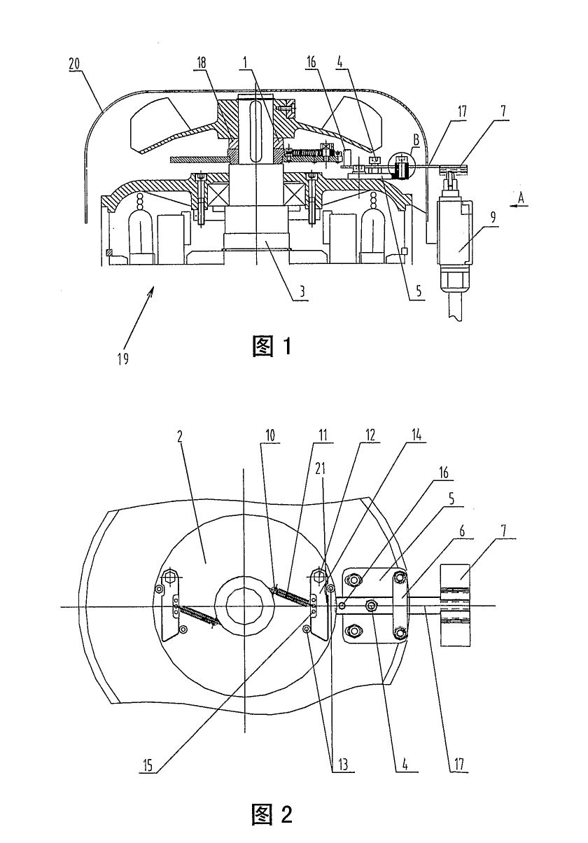

FIG. 1 is a schematic view illustrating the structure of a mechanical overspeed protective device according to an embodiment of the present invention. As shown in FIG. 1, the mechanical overspeed protective device according to the embodiment of the present invention consists of a rotation unit I and a control arm unit II. Referring to FIG. 2, the rotation unit I comprises a rotating bottom plate 2 and at least one centrifugal component mounted on the rotating bottom plate 2. The at least one centrifugal component consists of limiting screws 13, a spring 11 and a weight 14.

The rotating bottom plate 2 is a circular plate inserted over the main shaft 3 of the motor 19 so that it rotates with the main shaft 3. One end of the weight 14 is mounted on the rotating bottom plate 2 by means of a weight locating pin 12, so that it rotates around the locating pin 12. At least one aperture 15 is formed on one side of the weight 14. One embodiment of the present invention has three apertures. Obviously, the present invention is not limited in this way, since there can be any suitable number of apertures.

One end of the spring 11 is fixed near the center of the rotating bottom plate 2 by means of a locating screw 10, and the other end of spring 11 is hooked into one of the apertures 15 of the weight 14. Additionally, limiting screws 13 are disposed at least on one side of the weight 14. As shown in FIG. 2, in one embodiment, a limiting screw 13 is disposed on each side of the weight 14. In the state shown in FIG. 2, the main shaft 3 is prevented from rotating, and under tension of the spring 11, the weight 14 comes into contact with the limiting screw 13 located near the center of the plate, thus placing the weight 14 in a balanced state.

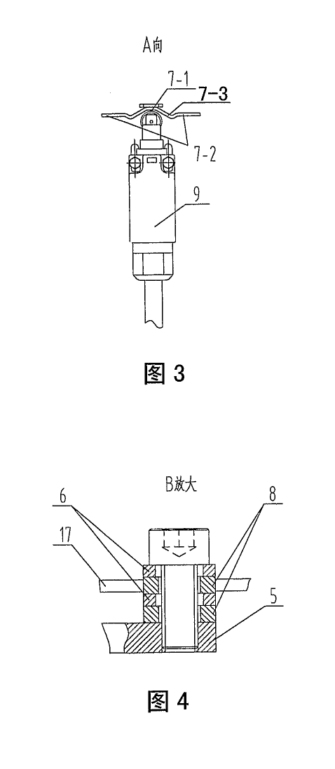

Referring to FIGS. 2 and 3, the control arm unit II comprises a drive rod 16, a support 5, a slide rod 17, a guide plate 6 and a bent rod 7 of predetermined shape. The drive rod 16, the slide rod 17 and the bent rod 7 jointly form an integral lever structure. Obviously, the drive rod 16, the slide rod 17 and the bent rod 7 may also be formed separately and then assembled together. The drive rod 16 and the bent rod 7 are located at two ends of the slide rod 17 respectively. In other words, the lever structure comprises the slide rod 17, which functions as a lever body, the drive rod 16 located at one end of the slide rod 17, and the bent rod 7 located at the other end of the slide rod 17. As shown in FIG. 2, the drive rod 16 may be formed into a cylindrical shape, and the bent rod 7 consists of a V-shaped bent surface 7-1 and planar surfaces 7-2 located on two sides of the V-shaped bent surface 7-1 respectively. Ridges 7-3 are formed between the V-shaped bent surface 7-1 and the planar surfaces 7-2. It should be noted that the V-shaped bent surface 7-1 of the bent rod 7 is not solely limited to the V-shaped bent surface, but may have another suitable shape, such as a curved surface.

The guide plate 6 is fixed to the support 5 by means of screws, and the slide rod 17 is mounted on the support 5 by means of a slide rod locating pin 4. The slide rod 17 is located within the guide plate 6 so that when the slide rod 17 rotates about the slide rod locating pin 4, the slide rod 17 will swing within the guide plate 6. Referring to FIG. 4, in one embodiment, washers 8 are also provided within the guide plate 6 between the guide plate 6 and the support 5.

The weights 14, the drive rod 16, the support 5, the slide rod 17, the guide plate 6 and the bent rod 7 may be made of galvanized steel sheets. Obviously, the present invention is not limited in this way as these components may be made of any other suitable material.

During the assembling process, the rotation unit I is inserted over the main shaft 3 of the motor 19. As shown in FIG. 1, a locating ring 1 is also provided on top of the rotation unit I on the main shaft 3 of the motor 19, in order to separate the fan 18 and the rotation unit I from each other. Also on top of the fan 18, a fan cover 20 is disposed to cover the fan. Referring to FIG. 2, the support 5 of the control arm unit II is fixed to an end cover of the motor 19 by means of screws, and the drive rod 16 is located near the rotating bottom plate 2. The bent rod 7 is located above the safety switch 9, and a top portion (e.g., a spherical top portion) of the safety switch 9 makes contact with the bent rod 7. Due to its resilience, the safety switch 9 is able to move up and down in a vertical direction shown in FIG. 9.

During use, the motor 19 operates, and the rotation unit I rotates with the main shaft 3 of the motor. When the main shaft 3 rotates at a speed no higher than a predetermined speed, the safety switch 9 stays below the V-shaped bent surface 7-1 of the bent rod 7 (see FIG. 3). In this state, the safety switch is switched on instead of being depressed, so that power is fed to the motor 19. As the rotation unit I rotates with the main shaft 3, the weight 14, due to the centrifugal force, overcomes the tension of the spring 11 to rotate about the weight locating pin 12 and extend outwardly. The distance to which the weight 14 extends increases with the increase of rotational speed of the motor 19. Once the rotational speed increases to a certain value, an engaging surface 21 of the weight 14 makes contact with the drive rod 16, and under the action of the limiting screws 13, the slide rod 17 rotates about the slide rod locating pin 4 and swings within the guide plate 6. The engaging surface 21 has an inclined surface which securely engages with the drive rod 16, in order to ensure that the control arm unit II will be actuated under predetermined overspeed conditions. The limiting screws 13 are used to limit the travel distance of the weight 14.

Upon rotating to a certain degree, the planar surface 7-2 of the bent rod 7 comes in contact with the safety switch 9 (not shown). As shown in FIG. 3, since the level of the planar surface 7-2 of the bent rod 7 is lower than that of the V-shaped bent surface 7-1, the safety switch 9 is depressed by the planar surface 7-2 to move downwards in a vertical direction shown in FIG. 3. Through the above operations, the safety switch 9 is depressed, and the motor 19 is thereby switched off. Additionally, after the safety switch 9 has moved from the position where it makes contact with the V-shaped bent surface 7-1 to the position where it makes contact with the planar surface 7-2 of the bent rod 7, the ridges 7-3 of the bent rod 7 serve to prevent automatic resetting of the safety switch 9, even after the weight 14 no longer makes contact with the drive rod 16, thus ensuring a secure switching-off of the circuit.

In a preferred embodiment of the present invention, the centrifugal components consist of two limiting screws 13, two springs 11 and two weights 14. In one implementation, each set of two centrifugal components are located on the rotating bottom plate 2 essentially symmetrically. Obviously, although it is preferable that the two sets of centrifugal components be disposed on the rotating bottom plate 2 symmetrically, they may also be disposed on the rotating bottom plate 2 separately at other predetermined angles. Similar to the above implementation, one end of each of the springs 11 is fixed near the center of the rotating bottom plate 2 by means of the locating screw 10, and the other end of each spring 11 is hooked into one of the apertures 15 of the weight 14. The four limiting screws 13 are divided into two groups with two screws in each group, and two limiting screws 13 in each group are fastened to the rotating bottom plate 2 at two sides of the corresponding weight 14, respectively.

In the above structures, on the one hand, since the two substantially identical centrifugal components consisting of two sets of springs, weights and limiting screws are symmetrically mounted on the rotating bottom plate 2, it is easy to accomplish balancing, and since the components are mounted after being well balanced, the device as a whole may run smoothly without any excitation due to shock. On the other hand, bidirectional overspeed protection can be accomplished by using two centrifugal components. More specifically, when the rotating bottom plate 2 rotates in the counterclockwise direction shown in FIG. 2, the right centrifugal component in FIG. 2 will operate to serve the overspeed protection function; and when the rotating bottom plate 2 rotates in the clockwise direction also shown in FIG. 2, the left centrifugal component in FIG. 2 will operate to serve the overspeed protection function.

In the above implementations, the spring 11 can be hooked into any of the apertures 15 on the weight 14. The apertures 15 are used to adjust the tension of the different springs and the clearance between the control arm unit II and the weight 14, thereby compensating for the manufacturing tolerances in the stiffness of the springs, reducing the influence imposed by differences between individual springs, and making the entire device more reliable.

Additionally, in an embodiment, at least one screw hole is provided in the weight 14 for convenience of testing the overspeed protective device on site. More specifically, by fixing a mass block (not shown) to the weight 14 using a socket head screw M4*8 during a test on site, an overspeed test can be performed without using an additional frequency converter. Since the mass of the mass block is easy to control, the device thus tested on site can operate correctly in response to an overspeed state when the mass block is removed.

Although a motor for an escalator and moving walkway was used as an example to illustrate the present invention, it is not intended to limit the present invention; rather, the mechanical overspeed protective device of the present invention can be applied to any machines or apparatuses having a rotary shaft for overspeed protection purpose.

Although the general inventive concepts of the present invention were explained in detail with reference to the attached drawings, persons with ordinary skill in the art may appreciate that various modifications, changes or alterations may also be made.

1-16. (canceled)

17. An overspeed protective device connected to a rotary shaft of a machine, comprising:
a rotation unit, comprising:
a rotating bottom plate received at least partially over the rotary shaft;
at least one centrifugal component mounted on the rotating bottom plate and comprising:
a spring, a weight and limiting screws, wherein one end of the weight is pivotally connected to the rotating bottom plate, one end of the spring is connected to the weight and the other end is fixed to the rotating bottom plate, and the limiting screws are disposed on at least one side of the weight; and
a control arm unit, comprising:
a drive rod, a slide rod and a bent rod, wherein the drive rod and the bent rod are located on sides of the slide rod, respectively, and the drive rod is configured to engage with the weight of the rotation unit.

18. The overspeed protective device of claim 17, wherein the drive rod, the slide rod and the bent rod form an integral structure.

19. The overspeed protective device of claim 18, wherein the control arm unit is able to rotate about a slide rod locating pin disposed on the slide rod.

20. The overspeed protective device of claim 17, wherein the drive rod has a cylindrical shape;
the bent rod has a V-shaped bent surface and planar surfaces located on both sides of the V-shaped bent surface.

21. The overspeed protective device of claim 17, wherein the limiting screws are disposed on sides of the weight.

22. The overspeed protective device of claim 17, wherein the rotating bottom plate has a circular shape, and
the at least one centrifugal component has two sets of centrifugal components.

23. The overspeed protective device of claim 22, wherein the two sets of centrifugal components are symmetrically mounted on the rotating bottom plate.

24. The overspeed protective device of claim 17, wherein the control arm unit comprises:
a support fixedly connected to the machine;
a slide rode locating pin; and
a guide plate,
wherein the guide plate is fixed to the support, and the slide rod is mounted on the support by the slide rod locating pin and is located within the guide plate.

25. The overspeed protective device of claim 24, comprising:
a washer provided between the guide plate and the support.

26. The overspeed protective device of claim 17, comprising:
at least one aperture formed in an area where the weight and the spring are connected to each other, and one end of the spring is hooked into the at least one aperture.

27. The overspeed protective device of claim 26, comprising three of the apertures.

28. An escalator using the mechanical overspeed protective device of claim 17, wherein the escalator comprises a motor and the rotation unit is connected to the motor.

29. A passenger conveyor comprising:
a machine having a rotary shaft;
a safety switch for controlling electric current provided by the machine;
a rotation unit connected to the rotary shaft so that it rotates with the rotary shaft;
a first centrifugal component mounted on the rotation unit, comprising a weight having one end pivotally connected to the rotation unit; and
a control arm unit, comprising a first end adapted to engage with the weight and a bent rod that comprises a first surface that allows power to be fed to the machine when it engages with the safety switch, a second surface that prevents the power from being fed to the machine when it engages with the safety switch and a third surface that is used to prevent movement between the first surface and the second surface.

30. The passenger conveyor of claim 29, wherein the first weight engages with the control arm unit to cause the second surface to engage with the safety switch when the rotation of the rotation unit exceeds a selected speed.

31. The passenger conveyor of claim 30, wherein the weight comprises an engagement surface, which is adapted to securely engage with the control arm unit first end when the rotation of the rotation unit exceeds the selected speed.

32. The passenger conveyor of claim 29, comprising a second centrifugal component comprising a second weight having a second engagement surface, and wherein when the rotation unit rotates in a first direction, the engagement surface of the weight securely engages with the first end, and when the rotation unit rotates in a second direction, the engagement surface of the second weight securely engages with the first end.
